(19) United States
(12) Patent Application Publication
(10) Pub. No.: US 2002/0100276 A1
(43) Pub. Date: Aug. 1, 2002

(54) Master cylinder with booster failure compensation

(76) Inventor: Bernard Petin, Dayton, OH (US)

Correspondence Address: SCOTT A. MCBAIN, DELPHI TECHNOLOGIES, INC., Legal Staff Mail Code: 480-414-420, P.O. Box 5052, Troy, MI, 48007-5052, US

(21) Appl. No.: 09/775,302

(22) Filed: Feb. 1, 2001

(51) Int. Cl. B60T 13/00

(52) U.S. Cl. 60/547.1; 60/574

(57) ABSTRACT

A master cylinder is disclosed which is switched from a normal operating mode to a secondary mode when available vacuum is insufficient to operate the booster or at booster run-out. In these circumstances where the normal power assist from the booster is not available, the effective area of the input plunger of the master cylinder is reduced to reduce the manual actuating force required to generate braking pressure, thereby enabling the vehicle operator to more easily generate braking pressure.

### TECHNICAL FIELD

This invention relates to a master cylinder which is switchable between normal and booster failed modes and which requires a lower force for actuation in the booster failed mode.

### BACKGROUND OF THE INVENTION

Modern passenger cars and light trucks are normally provided with a vacuum powered brake booster which amplifies the force applied by the vehicle operator to actuate the vehicle master cylinder, which develops braking pressure to actuate the vehicle brakes. The master cylinder develops pressure in each of a pair of braking circuits, and is normally mounted directly on the brake booster, so that a “push through” link may be provided between the master cylinder and the brake pedal so that the vehicle operator may directly actuate the master cylinder (but without the power assist provided by the booster) upon failure of the booster.

Boosters commonly fail because the vehicle engine stalls. Since boosters commonly use engine manifold vacuum as a power source and provide a vacuum reserve sufficient for only a very few actuations when the vehicle engine is not running, manual operation of the master cylinder must be accommodated. However, since it is desirable to provide short pedal travel during normal power operation of the brake system, braking systems are designed to use the higher force output of modern brake boosters to shorten pedal travel while providing the force necessary to operate the vehicle brakes. However, during the aforementioned manual operation, the force required to actuate the brakes may be excessive. Accordingly, expensive fail safe measures have been provided to reduce failed mode actuation forces to an acceptable level.

Manual actuation of the master cylinder also occurs when the brake application forces generated by the vehicle operator exceed the maximum output force that the booster can supply. This maximum force is commonly referred to as booster “run-out”. Accordingly, it is also desirable to minimize manual actuation forces at booster run-out.

### SUMMARY OF THE INVENTION

According to the present invention, the master cylinder primary piston, which develops pressure in the primary braking chamber, is provided with a shoulder opposing the face of the primary piston exposed to pressure in the primary chamber. The shoulder cooperates with the master cylinder housing to define a pressure cavity. During normal operation of the booster, the cavity is communicated to the master cylinder reservoir, so that the primary piston has an effective area equal to the entire cross-sectional area of the primary piston. Upon booster failure, or upon booster run-out, the cavity is communicated to the primary braking circuit, thus reducing the effective area of the plunger by the cross-sectional area of the shoulder. The smaller effective area of the primary piston during operation of the master cylinder in the booster failure mode or upon booster run-out correspondingly reduces the input forces required of the vehicle operator during booster failure or run out or generates a higher pressure in the master cylinder with the same input force. Since the available brake pedal travel cannot be used fully without vacuum in the booster, the working area of the master cylinder may be reduced and the resulting increase in pedal travel be used to lower actuation forces.

### BRIEF DESCRIPTION OF THE DRAWINGS

FIG. 1 is a cross-sectional view of a master cylinder made pursuant to the present invention and a fragmentary portion of the brake booster upon which the master cylinder is installed, the master cylinder being illustrated in the rest or brake released position;

FIG. 2 is a view similar to FIG. 1, but with the master cylinder illustrated in the brake applied position.

### DESCRIPTION OF THE PREFERRED EMBODIMENT

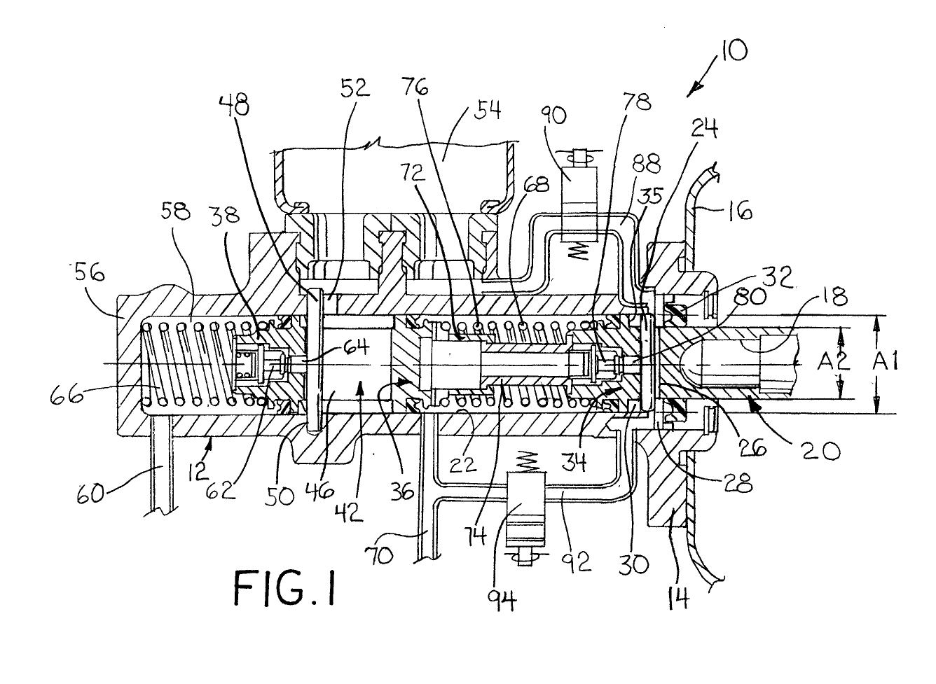

Referring now to the drawings, a master cylinder generally indicated by the numeral 10 made pursuant to the present invention includes a housing 12 having a mounting flange 14 which is secured to the rear portion 16 of a conventional vacuum booster. The vacuum booster amplifies the force applied by the vehicle operator and includes an output member (not shown), the end of which is received within socket 18 of a master cylinder input plunger 20, which is slidingly received within bore 22 defined within master cylinder housing 12. The booster normally operates the plunger 20 to effect a brake application, and also provides a direct link between the brake pedal and the plunger for manual actuation of the plunger 20 during booster failure due to lack of engine vacuum. The plunger 20 is an integral part of a primary master cylinder piston 34, which will be described in detail hereinafter. A pin 24 is received in an oversized transverse bore 26 in plunger 20. As will be described hereinafter, the pin 24 is urged against a circumferentially extending stop washer 28 when the master cylinder is in the brake released or rest position as illustrated in FIG. 1. The wall of the bore 22, the outer surface of the plunger 20, the stop washer 28, and shoulder 35 on piston 34 define a circumferentially extending cavity 30. A circumferentially extending seal 32 circumscribes the plunger 20 at stop member 28.

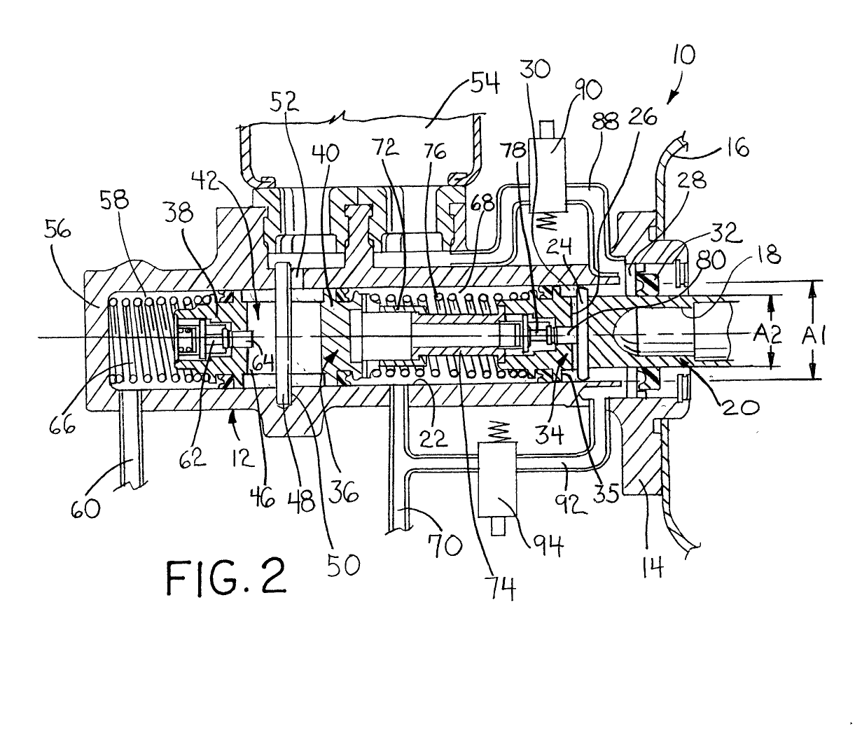

The primary master cylinder piston 34 and a secondary master cylinder piston 36 are slidably mounted in the bore 22 and are coaxial with each other. The secondary piston 36 includes opposite end portions 38,40 which are rigidly connected by a slotted portion 42 having a longitudinally extending slot 46. A stop pin 48 is secured in a bore 50 extending from bore 22 and extends through slot 46 and into a compensating port 52 which communicates with the fluid within master cylinder reservoir 54. Accordingly, the reservoir 54 is communicated with the cavity circumscribing the slotted portion 42 at all times. The end portion 38 cooperates with closed end 56 of bore 22 to define a secondary pressure chamber 58 therebetween, which is communicated to the vehicle brake actuators (not shown) actuated by the vehicle secondary braking circuit 60, which communicates with secondary pressure chamber 58. A spring loaded compensating valve 62 is mounted in the end portion 38 and includes a stem 64 which extends through the end portion 38 and is stopped by the stop pin 48 when the secondary piston 36 is in the rest or brake release position as illustrated in FIG. 1 to thereby open the valve. However, when a brake application is effected (FIG. 2), the stem 64 is moved away from the stop pin 48, permitting the compensating valve 60 to close. The end portion 38 is urged toward stop pin 48 by a secondary return spring 66.

The end portion 40 of secondary piston 36 cooperates with the primary piston 34 to define a primary master cylinder chamber 68 therebetween. Primary chamber 68 is communicated with primary braking circuit 70, which communicates braking pressure to the brake actuators (not shown) controlled by the primary braking circuit 70. A sleeve 72 extends from the secondary piston 36 toward the primary piston 34, and another sleeve 74 extends from the primary piston 34 toward the secondary piston 36. Sleeve 72 terminates in a radially inwardly extending stop surface which is urged against radially outwardly extending stop surface on sleeve 74 by return spring 76 when the master cylinder is in the rest or brake released position. A compensating valve 78 similar to compensating valve 62 is mounted in the primary piston 34, and includes a stem 80 which is stopped by the pin 24 engaging stop washer 28, which permits the primary piston 34 to move relative to pin 24 a distance equal to the clearance between the pin 24 and transverse bore 26 as the primary piston approaches the rest or brake release condition to thereby open the compensating valve 78. However, when the pin 24 is moved away from the stop washer 28 when a brake application is effected, the spring closes the compensating valve.

The primary and secondary pistons function in a manner well known to those skilled in the art to assure that braking pressure is available in at least one of the primary or secondary braking circuits in the event of failure of the other braking circuit. For example, in the case of failure in the secondary braking circuit 60, the portion 40 of secondary piston 36 bottoms out on stop pin 48 to permit the primary piston 34 to generate braking pressure in primary chamber 68 and primary braking circuit 70. In case of failure of the primary braking circuit 70, spring 76 collapses to permit the sleeve 74 to engage the end portion 40 of secondary piston 36, thus forming a rigid link between the primary piston 34 and secondary piston 36 to permit generation of braking pressure in the secondary chamber 58 and secondary braking circuit 60.

The cavity 30 is communicated to the master cylinder reservoir 54 by a first flow path 88, which includes a conventional normally open electrically actuated solenoid valve generally indicated by the numeral 90. The cavity 30 is also communicated to the primary braking circuit 70 through a second flow path 92, which includes a conventional, normally closed, electrically actuated solenoid valve 94. When a brake application is effected, movement of the plunger 20 and primary piston 34, and resulting movement of secondary piston 38 into secondary chamber 58 builds braking pressure in the primary and secondary braking circuits 70, 60 to effect a brake application. In this normal brake application, in which a power assist is provided by the vacuum brake booster, the pressure in cavity 30 is at reservoir pressure, since valve 90 is open to permit communication of reservoir pressure through the flow path 88 into cavity 90 and communication through flow path 92 is prevented by valve 94. Accordingly, the effective area of the plunger 20 will be the same as the diameter of bore 22, indicated as area A1. In this normal operating mode, full braking pressure is developed relatively quickly while requiring a relatively large activating force, which is readily available from the brake booster. However, this force may be too great to be easily generated by a normal vehicle operator in the event of booster vacuum failure.

According to the invention, a conventional vacuum sensor (not shown) is provided to generate an electrical signal when the booster is in a failure mode due to lack of engine manifold vacuum. When this occurs, electrically actuated solenoid valves 90,92 are operated to close off communication between cavity 30 and the reservoir 54 and to open communication between cavity 30 and the primary brake circuit 70. Accordingly, a pressure level is communicated to the cavity 30 that is substantially the same as that in the primary chamber 68. Since the pressure of the primary braking circuit 70 in cavity 30 acts on shoulder 35 which opposes the pressure in the primary chamber 68, the effective area of the plunger is reduced by the area of the shoulder 35. This reduced effective area is indicated at A2 in the Figures. Since the area is reduced, the actuating force necessary to develop a desired braking force will also be reduced. When the brakes are released, both solenoid valves are de-energized. The solenoid valves may also be actuated at booster run-out, to thereby also reduce the actuation force that would otherwise be required to increase braking pressure beyond that available at booster run-out.

Although the invention has been described as incorporating two separate electrically actuated solenoid valves 92, 94, since both of the valves are actuated and de-actuated at the same time, the flow paths 88 and 92 may be re-routed so that only a single solenoid actuator is required to actuate both the valves 90,92.

1. Master cylinder for a vehicle braking system having a primary brake circuit, a secondary brake circuit, and a brake booster for amplifying brake actuation forces applied by a vehicle operator for actuating said master cylinder, said master cylinder comprising a housing defining a bore therewithin, primary and secondary pistons slidable in said bore and cooperating with said bore to define a primary chamber communicated with said primary brake circuit and a secondary chamber communicated with said secondary brake circuit, said bore having an open end receiving an actuating plunger extending from said primary piston, said booster supplying a power assist to force said plunger in a direction urging said primary and secondary pistons in a direction effecting a brake actuation when the master cylinder is in a normal mode to develop braking pressure in said circuits, and a switchable hydraulic circuit for changing the effective area of said face of said primary piston from a larger effective area in said normal mode to a smaller effective area when the master cylinder is in a secondary mode when amplification of braking forces by said booster is not available to thereby reduce the brake actuation forces necessary to cause said plunger to move said pistons.

2. Master cylinder as claimed in claim 1, wherein said primary piston has larger and smaller diameter portions defining a shoulder therebetween, said shoulder cooperating with said bore and said plunger to define a pressure cavity therebetween, said switchable hydraulic circuit changing the pressure level in said cavity in response to said secondary mode to thereby change the effective area of said primary piston.

3. Master cylinder as claimed in claim 2, wherein said switchable hydraulic circuit communicates a lower pressure level into said cavity when the master cylinder is in said normal mode and a higher pressure level into said cavity when said master cylinder is in said secondary mode.

4. Master cylinder as claimed in claim 2, wherein said master cylinder includes a reservoir storing fluid for communication into said braking circuits during operation of said master cylinder, said switchable hydraulic circuit communicating said cavity to said reservoir when said master cylinder is in said normal mode.

5. Master cylinder as claimed in claim 4, wherein said switchable hydraulic circuit communicates said cavity with one of said braking circuits and closes communication between said cavity and said reservoir when the master cylinder is in the secondary mode.

6. Master cylinder as claimed in claim 5, wherein said switchable hydraulic circuit includes a first flow path communicating said cavity with said reservoir and a second flow path communicating said cavity with said one braking circuit.

7. Master cylinder as claimed in claim 6, wherein said switchable hydraulic circuit includes electrically actuated valve means switchable from a normal condition blocking said second flow path and opening said first flow path when the master cylinder is in the normal mode to a second condition blocking said first flow path and opening said second flow path when the master cylinder is in the secondary mode.

8. Master cylinder as claimed in claim 2, wherein said switchable hydraulic circuit includes a flow path communicating said cavity with one of said braking circuits, and an electrically actuated valve responsive to failure of said booster for blocking communication through said first flow path when the master cylinder is in the normal mode and permitting communication through said first flow path when the master cylinder is in the secondary mode.

9. Master cylinder as claimed in claim 2, wherein said switchable hydraulic circuit includes electrically actuated valve means responsive to failure of said booster and switchable from a first condition venting said cavity when the master cylinder is in the normal mode to a second condition communicating said cavity with one of said braking circuits when the master cylinder is in the secondary mode.

10. Master cylinder for a vehicle braking system having a primary brake circuit, a secondary brake circuit, and a brake booster for amplifying brake actuation forces applied by a vehicle operator for actuating said master cylinder, said master cylinder comprising a housing defining a bore therewithin, primary and secondary pistons slidable in said bore and cooperating with said bore to define a primary chamber communicated with said primary brake circuit and a secondary chamber communicated with said secondary brake circuit, said bore having an open end receiving an actuating plunger extending from said primary piston, said booster supplying a power assist to force said plunger in a direction urging said primary and secondary pistons in a direction effecting a brake actuation when the braking system is in a normal mode, said primary piston having larger and smaller diameter portions defining a shoulder therebetween, said shoulder cooperating with said bore and said plunger to define a pressure cavity therebetween, and valve means for switching the pressure level in said cavity in response to switching of said master cylinder from said normal mode to a secondary mode when amplification of braking forces by said booster is not available.

11. Master cylinder as claimed in claim 10, wherein said master cylinder includes a reservoir storing fluid for communication into said braking circuits during operation of said master cylinder, said valve means including means for communicating said cavity to said reservoir when said master cylinder is in said normal mode.

12. Master cylinder as claimed in claim 11, wherein, said valve means includes means for communicating said cavity to one of said braking circuits when said master cylinder is in said secondary mode.

13. Master cylinder as claimed in claim 10, wherein said master cylinder includes a first flow path communicating said cavity to said reservoir and a second flow path communicating said cavity to one of said braking circuits, said valve means including electrically actuated means for opening communication through said first flow path and closing communication through said second flow path when the master cylinder is in the normal mode and for closing communication through said first flow path and opening communication through said second flow path when said master cylinder is in said secondary mode.

14. Master cylinder as claimed in claim 13, wherein said electrically actuated means includes electrically actuated valves in each of said first and second flow paths actuable between an open condition permitting communication through its corresponding flow path to a closed condition closing communication through said flow path.

15. Master cylinder for a vehicle braking system having first and second brake circuits and a brake booster for supplying a power assist for amplifying brake actuation forces applied by a vehicle operator for actuating said master cylinder, said master cylinder including a reservoir and primary and secondary pitons for developing braking pressure in each of first and second braking circuits when a brake application is effected, booster output responsive means for switching said master cylinder from a normal mode to a secondary mode when amplification of braking forces by said booster is not available, said booster output responsive means including switching means for changing the effective area of said primary piston when the master cylinder switches from said normal to said secondary mode.

16. Master cylinder as claimed in claim 15, wherein said primary piston includes a face opposing said effective area of said primary piston, said switching means including means for communicating said face to said reservoir when the master cylinder is in the normal mode.

17. Master cylinder as claimed in claim 16, wherein said switching means includes means for communicating said face to one of said braking circuits when the master cylinder is in the secondary mode.

18. Master cylinder as claimed in claim 15, wherein said switching means includes a first flow path communicating said reservoir to said face, a second flow path communicating said face to one of said braking circuits, and switchable valve means for controlling communication through said flow paths to communicate said face to said reservoir when the master cylinder is in the normal mode and to said one braking circuit when the master cylinder is in the secondary mode.

19. Master cylinder as claimed in claim 18, wherein said switchable valve means includes a first electrically actuated valve means for opening and closing communication through said first flow path and a second electrically actuated valve means for opening and closing communication through said second flow path.
